(19) United States
(12) Patent Application Publication
(10) Pub. No.: US 2017/0094364 A1
(43) Pub. Date: Mar. 30, 2017

(54) SOCIAL NEWS AGGREGATION AND DISTRIBUTION

(71) Applicant: Mobdub, LLC, Brooklyn, NY (US)

(72) Inventors: Omar Karim, Brooklyn, NY (US); Matthew T. Randak, Brooklyn, NY (US)

(21) Appl. No.: 15/277,905

(22) Filed: Sep. 27, 2016

Related U.S. Application Data
(60) Provisional application No. 62/233,989, filed on Sep. 28, 2015.

(51) Int. Cl. H04N 21/482; H04N 21/45; H04N 21/258; H04N 21/61; H04N 21/472; H04N 21/475

(52) U.S. Cl. CPC H04N 21/4825; H04N 21/472; H04N 21/4756; H04N 21/4826; H04N 21/25891; H04N 21/6125; H04N 21/4532

(57) ABSTRACT

A device and method of providing a social news platform are provided. News media files and metadata are received from subscribers of the social news platform. Each received news media file is rated based on predetermined criteria. Each news media file and its corresponding metadata is stored. One or more news media files that are related to a news topic are retrieved. A custom channel comprising a dynamic playlist of the one or more news media files that are related to the news topic is created. An order in which to present the one or more news media files of the custom channel is determined based on the rating of each media file in the custom channel. The custom channel comprising the one or more news media files is provided in the determined order, to be presented to user devices of the subscribers.

### CROSS REFERENCES TO RELATED APPLICATIONS

The present application claims the benefit of priority under 35 U.S.C. §119 from U.S. Provisional Patent Application Ser. No. 62/233,989, entitled “Social News Aggregation and Distribution,” filed on Sep. 28, 2015, which is hereby incorporated by reference in its entirety for all purposes.

### BACKGROUND

Interactive television ranges from passive, where the television or a channel is merely turned ON or OFF to moderate—where content such as news or movies can be watched on demand, to highly interactive—where a member of the audience can affect the outcome of the programming. Highly interactive television is still at its infancy in that it does not sufficiently engage an audience in a meaningful way to encourage participation and contribution of content. With the advent of smart TVs and other content streaming devices, viewers are increasingly expecting to have access to content that suits their taste and viewing habits.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture of a social news platform that performs social aggregation and distribution of news content.

FIG. 2 is a flow diagram of an example process for collecting news media files and generating metadata for such news media files via the social news platform.

FIG. 3 is a flow diagram of an example process for providing news media files that pertain to a news topic to a user using the social news platform.

FIG. 4 is a flow diagram of an example process for managing the user experience of a user that is interacting with the social news platform through a user device.

FIG. 5 is a flow diagram of an example process for managing the user experience of a user that is interacting with the social news platform through a user device and a companion device.

FIGS. 6 to 14 provide views of a navigation workflow through the application, consistent with exemplary embodiments.

FIG. 15 provides a functional block diagram illustration of a computer hardware platform that may be used to implement the functionality of the one or more computing devices of the social news platform.

### DETAILED DESCRIPTION

### Overview

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

This disclosure generally relates to an audience engagement platform, and more particularly, to an audience engagement platform for news media for connected TV devices, such as smart TV's, as well as other user devices. In one aspect, a social news platform leverages new application development capabilities in platforms such as Apple TV, Android TV, Amazon Fire TV, Roku, Google Chromecast, and the like, to create an interactive way to experience news on a television screen.

A social news platform receives news media files from various user devices of subscribers to a social news platform. Here, a subscriber is not necessarily a paying customer, but rather a user with an account on the social news platform, where the social news platform has sufficient information about the user to collect profile and/or preference information sufficient to make determinations on what content to route to the user and in which way. Metadata is received for one or more corresponding news media files from the subscribers. The social news platform rates each received news media file based on predetermined criteria. Each news media file (together with its corresponding metadata) is stored by the social news platform. A custom channel comprising a cluster of the one or more news media files that are related to a news topic are created. The social news media platform determines one or more orders in which to present the one or more news media files of the custom channel based on the rating and/or metadata of each media file in the custom channel. The custom channel comprising the one or more news media files is presented to user devices of the subscribers in the determined order.

In one aspect, the social news platform described herein combines the crowd-sourced submission and ranking methods of social news aggregators with the immersive video interface provided by a smart TV. The core workflow of the platform is purposefully simple to encourage broad usage. In various embodiments, users may submit videos and related metadata to the social news platform. The users may include human users and/or automated systems acting on behalf of human users and corporations. The social news platform may further facilitate the ranking and curation of the submitted videos by the wider user community. Additionally, the social news platform may build dynamic video playlists for user consumption based on rankings and metadata (e.g., the highest rated videos with the hashtag #ElectionDebate).

The following discussion maps the core workflow to more specific system capabilities and expands on the range of features available. Note that the content submission and consumption features are described separately but provide a unified workflow available to a single user or multiple users.

### Example Architecture

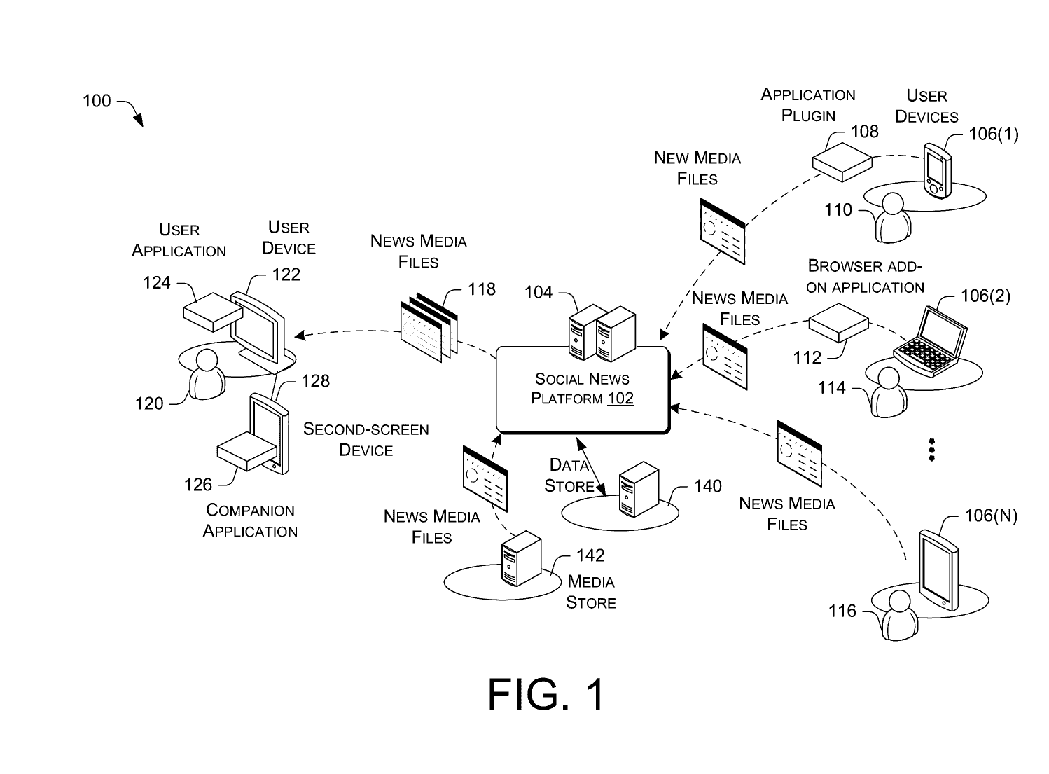

FIG. 1 illustrates an example architecture 100 of a social news platform that performs social aggregation and distribution of news content. The social news platform 102 may include one or more software applications that are implemented by one or more computing device(s) 104. The computing device(s) 104 may include general purpose computers, such as desktop computers, tablet computers, laptop computers, servers, and so forth. However, in other embodiments, the computing device(s) 104 may include smart phones, game consoles, or other electronic devices that are capable of receiving inputs, processing the inputs, and generating output data. Each of the computing device(s) 104 may be equipped with a communication interface, one or more processors, memory, and hardware. The communication interface may include wireless and/or wired communication components that enable the computing device to transmit data to and receive data from other networked devices. Each of the processors may be a single-core processor, a multi-core processor, a complex instruction set computing (CISC) processor, or another type of processor. In other embodiments, the computing device(s) 104 may be virtual computing devices in the form of virtual machines or software containers that are hosted in a cloud. The computing device(s) 104 are discussed in further detail in a later section.

The social news platform 102 may receive news media files from multiple user devices, such as the user devices 106(1)-106(N). Today, user devices may come in the form of portable handsets, smart-phones, tablet computers, personal digital assistants (PDAs), and smart watches, although they may be implemented in other form factors, including consumer, and business electronic devices such as smart TV's. For example, the user device 106(1) may be a mobile phone, the user device 106(2) may be a laptop computer, the user device 106(N) may be a tablet computer, and the user device 122 may be a smart TV or a regular TV that has been transformed into a smart TV via a dongle such as Roku, Chromecast, Amazon Fire TV Stick, Apple TV, etc.

Each news media file may be a multimedia file that includes video, photo, text, and/or audio data. The news media files may be uploaded from the user devices 106(1)-106(N) in multiple ways. For example, the user device 106(1) may include an application plugin 108 for a mobile application that is running on the user device 106(1). The mobile application may be provided by a third party video hosting platform. The application plugin 108 may enable a user 110 of the user device 106(1) to upload news media files directly from the mobile application or provide a link from which the social news platform 102 can download the news media file from. An exemplary link may be a hypertext markup language (HTML) link using an anchor to an internet address such as a Uniform Resource Identifier (URI), or alternatively, to a local data store. Other exemplary links may be implemented as an input event handler to navigate to a URI.

In another example, the user device 106(2) may include a browser add-on application 112 for a web browser that executes on the user device 106(2). An add-on application 112 is sometimes also known as a “browser extension.” The browser add-on application 112 may enable a user 114 of the user device 106(2) to upload news media files from the websites of third party video hosting platforms. Such news media content providers may include a traditional news station, a social networking site, etc., collectively represented by the media store 142.

Alternatively, the user 114 of the user device 106(2) may use a bookmark to navigate to a web page and/or web applet hosted by the social news platform 102. Accordingly, the web page or web applet may enable the user 114 to upload the news media files of the third party video hosting platforms 142 to the social news platform 102.

In an additional example, the social news platform 102 may provide a website that enables users to post news media files or links to news media files directly to the social news platform 102. Alternatively, the social news platform 102 may provide a web-based application interface that enables users to record and/or stream live and on-demand media files directly to the social news platform 102. For example, the user 116 may use a web browser or an application on the user device 106(N) to access the web-based application interface to upload media files or to provide links of the news media files to the social news platform 102. The social news platform 102 may store the uploaded media files and/or link thereof in a data store 140 for subsequent processing and analysis. The data store 140 may include one or more databases, such as relational databases, object databases, object-relational databases, and/or key-value databases. In various embodiments, the data store may be hosted by the computing device(s) 104 or by one or more cloud service providers. For discussion purposes, the data store 140 and the computing device(s) 104 are illustrated in FIG. 1 to be on separate platforms. However, the functionality of the social news platform 102 and the data store 140 can be combined on a single platform as well. Thus, the computing device(s) 104 and the data store 140 need not be stand-alone computing devices, but can be combined on a single platform or hosted in a cloud.

In some embodiments, the plugins, application add-ons, web interfaces, and/or web-based application interfaces may also enable users to provide metadata for the uploaded media files. For example, the users may enter hashtags, statistics, location information, and text that describe the news media files. The users may also rank the news media files, content authors, curators (individuals such as tastemakers and subject matter experts, who apply their opinions to content via selecting and ranking the content), and/or content sources of the news media files.

A user may consume content that is stored by the social news platform 102 by selecting and downloading the news media files 118 from the social news platform 102 for viewing. For example, a user 120 may use a user device 122 to retrieve the news media files 118 from the social news platform 102. The user device 122 may be a smart TV that is equipped with a dedicated user application 124. In addition to enabling the user application 124 to select and view news media files, the user application 124 may also provide the user 120 with the ability to perform other tasks with respect to the news media files being consumed, as described herein. For example, a user may use the user application 124 to watch a continuous stream of system-wide content submissions ordered by ranking, create custom channels based on metadata filters, select related news media files, subscribe to custom playlists of news media files created by other users, and/or so forth.

In alternative embodiments, the social news platform 102 may enable the users to select and consume news media files, as well as perform other tasks with respect to the news media files using alternative user interfaces. Such user interfaces may include user interfaces on smart phones, tablet computers, smart watches, etc. In such embodiments, the social news platform 102 may provide alternative user applications and/or provide web interfaces that are accessible to web browsers on such alternative platforms.

In some embodiments, the user 120 may install a companion application 126 association with the social news platform on a second-screen device 128. The second-screen device 128 may automatically display content related to the news media file that is currently being displayed by a primary user device, such as the user device 122, of the user 120. The second-screen device 128 may be used to browse content for subsequent viewing on the primary device, as well as perform other tasks such as ranking news media files and adding metadata as further described in this disclosure. The interaction of the second-screen device 128 with the user device 122, sometimes referred to herein as a first screen device, is discussed in more detail later.

The various user devices and the social news platform 102 may communicate with each other using wired or wireless communication connections. For example, the wired communication connections may include a local area network (LAN), a wide area network (WAN), and/or so forth. The wireless communication connections may include Wi-Fi, Bluetooth, cellular, near field communication (NFC) connections. Further, the various devices may be equipped with processors, memory, and/or other device hardware in a similar manner as described with respect to the one or more computing device(s) 104.

### Content Submission

As mentioned above, users may add content to the social news platform 102 in a variety of ways. In one example, a news media file (e.g., a video) may be shared with the social news platform 102 via an application plugin 108 for a mobile application that is running on a user device, such as user device 106(1). The news media file may be provided by a third party media content hosting platform (e.g., media store 142), such as YouTube, Facebook, Daily Motion, etc. This interaction between the user device 106(1) and the social news platform 102 may be facilitated by the application plugin 108 which may be different for each user device platform, such as IOS, android, Windows, etc.

In one embodiment, a news media file may be shared with the social news platform 102 via a bookmarklet or “add on,” collectively referred to herein as a browser enhancement, that may be used by various web browsers, such as, but not limited to, Chrome, FireFox, Internet Explorer, Safari, etc. Such browser enhancement may include JavaScript commands that provide additional features to the respective browser, such as facilitating the sharing of the news media file from a website of one or more third party media content hosting platforms 142.

In one embodiment, a news media file may be shared with the social news platform 102 by posting news media files or links to news media files directly to the social news platform 102. Alternatively, the social news platform 102 may provide a web-based application interface that enables users to record and/or stream live and on-demand media files directly to the social news platform 102.

Users subscribed to the social news platform 102 may provide metadata for each media file. Such metadata may include a variety of textual annotations, such as captions, comments, tags, ancillary information, and links. For example, during a submission of a news media file (e.g., by either providing the actual news media file or a link thereto), hashtags may be provided via the user device to provide commentary or description of the news media file. For example, a user may annotate a political speech as #politics, #election, #republican convention, #fact-check, etc. In some embodiments, metadata has a time element associated with a news media file, where the annotation may be applicable for a particular time segment of the content of the news media file. For example, the metadata may specify “great response” for a first time segment and “inconsistent answer” for a second time segment of the same news media file. In this regard, it is noted that regular text may be used to describe the content (e.g., without the use of a hashtag).

In one embodiment, when metadata is provided by a user device, to the social news platform 102, a geolocation of the user device is recorded. The geolocation may be determined in various ways. For example, a user may manually enter location information into their user device upon a prompt from the plugin application. Alternatively, the geolocation may be determined automatically via a global positioning receiver of the user device or via cellular triangulation and/or multilateration. In one embodiment, the geolocation may be sent to the social news platform 102 within the same data packet as the metadata. By virtue of being able to track the geolocation of the metadata for a news media file, it is possible for the social news platform 102 to aggregate the news media files 118 more appropriately for the respective audience as discussed in more detail below.

In one embodiment, a user device can be used to aggregate related news media content topics into a news media package. For example, a user may select several news media files that the user deems to belong together, such as a first video clip of an athlete breaking a world record, and a picture of the same athlete in a family photograph. Thus, a user device may be used to indicate that several news media files to belong together. An indication may come in the form of a binary setting such as on/off, yes/no, and related/not-related.

In one embodiment, a user can add ancillary information related to the news media file in the data packet that is submitted to the social news platform 102. For example, additional data, such as polling statistics about an election, the name of the university a candidate attended, the candidate's views on particular topics, etc., may be added as an annotation of the news media file (or media file group).

In one embodiment, the ancillary information that a news media file is annotated with need not be directly related to the news media file. Rather, the information may be based on information that may be of interest to the consumer of the news media file, such as the present weather conditions, present stock quotes, etc. In this regard, a user may enter the ancillary information (or a link to the ancillary information) as an annotation of the news media file. Annotating a news media file with such ancillary information may later better match the recipient with the news media file. For example, a user may prefer to watch a video of a debate while being informed of the present weather and stock quotes.

A user may rank a news media file (e.g., based on their personal viewing preferences). To that end, in various embodiments, a user can make a binary assertion of whether they appreciate the news media file. Alternatively, a suitable rating scale may be used to assign a value of appreciation. The score may be alpha-numeric (e.g., 0 to 10, A to F), descriptive (e.g., poor, average, good, and excellent), based on color (e.g., red, green, and yellow), or any other suitable rating scale. Similarly, news media packages may be ranked based on individualized user preferences. Still further, content authors, curators, and/or sources of the news media file (and/or news media package) may be ranked based on individual viewing preferences. Such individualized user ratings may be used as a basis for the social news platform 102 to later provide the tailored one or more news media files to an appropriate recipient.

### Content Consumption

As mentioned previously, a subscriber to the social news platform 102 may consume news content by selecting and downloading the news media files 118 from the social news platform 102 for viewing. To that end, a user 120 may use a user device 122 to retrieve the news media files 118 from the social news platform 102. A user 120 can select news media files to view in a variety of ways. In instances where dynamic playlists are assembled, the social news platform 102 may attempt to push news media files and their corresponding metadata to users, which may be performed in real-time, such that the playlists may be continuously updated and reflect the most current state of the data store 140. In other scenarios, news media files may be pulled by a user device from the social news platform 102 based on selections and/or searches. A search for content may be based on an alphanumeric entry, selection from a prepopulated list, and/or using voice input into the user device.

In one embodiment, a subscribed user 120 to the social news platform 102 may view media content by selecting a continuous stream of system-wide media file submissions. For example, the continuous stream of media files may be based on various parameters, such as (i) ranking (e.g., highest average rating by other subscribed users of the system), (ii) timeliness (e.g., more recent media files are provided first), (iii) duration (e.g., the shortest or longest media files are provided first), and (iv) geolocation (e.g., the news media files that were submitted from a geolocation that is closest to the viewer is provided first). Of course, other suitable metadata filters may be used as well. Accordingly, a subscribed user may view the media content by selecting the parameter of interest within a topic channel.

In one embodiment, a subscribed user 120 of the system herein may create a custom channel of news media files, sometimes referred to herein as a news media package, based on specific metadata filters such as hashtag and/or location. For example, a subscribed user may manually enter a hashtag, such as the most recent videos tagged #ElectionDebate and #Clinton and posted from New Hampshire to create a channel of news media files. These media files can further be ordered and/or filtered based on ranking, timeliness, duration, etc., as discussed above. In one example, the social news platform 102 may suggest frequently used and trending hashtags to facilitate channel creation (e.g., #News, #Politics, #Sports, #Weather, #ElectionDebate, etc.). These channels may be saved by the subscribed user for subsequent reference and/or to continue watching the news media files and corresponding annotations.

In one embodiment, a subscribed user 120 may select a stream of media content submissions related to a news media file currently being watched. For example, the user may be offered various selections on a user interface of the user device, such as “More on this Story” or “Similar Videos.” The social news platform 102 may combine user submitted metadata related to a news media file with clustering techniques to create automated story (i.e., media package) of a related media content. For example, three substantially similar media files in the form of videos are submitted by different user devices to the social news platform 102. Each user may provide metadata to the corresponding news media file in the form of annotations. The social news platform 102, upon determining that the news media files are substantially similar, may use the one that has the best audio and/or video resolution, while combining the metadata from the various users. In this way, relevant metadata related to a news media file is preserved and can be made available to a subscribed user 120 in the best quality available.

In one embodiment, a subscribed user 120 may subscribe to a playlist that is curated and/or maintained by another subscribed user (e.g., 106 (1) to 106(N)), collectively referred to herein as a curated playlist. Such curated playlists may be ranked according to popularity. A subscribed user 120 may also subscribe to a known content source (e.g., media store 142) from the social news platform 102 content directory, such as CNN, The Huffington Post, etc. Thus, such known sources of media content, represented herein by media store 142, may be viewed as a provider of a curated playlist.

In one embodiment, a subscribed user 120 may sign into an existing account on a social network, such as, Twitter, Facebook, Instagram, Snapchat, etc., to retrieve media files therefrom. Thus, media content may be provided from various social networks to the social news platform 102. In one embodiment, a metadata feed, such as media rich site summary (MRSS) may be used for syndicating multimedia files for content providers.

A subscribed user 120 may browse live and on-demand news guides that may be maintained by the social news platform 102. Such news guides may provide listings of national, local, and/or social media sources. For example, the social news platform 102 may indicate what is presently playing on CNN, Fox News, MSNBC, etc., as well as what is trending in social media sources such as Facebook, Twitter, etc.

The social news platform 102 may add multimedia overlays to the screen of the user device. Such overlays may include, but are not limited to, clocks, news tickers, stock quotes, sports scores, weather forecasts, poll results, statistical data, and social network updates from Twitter, Facebook, and other third party platforms. For example, the social news platform 102 may provide an extensible software development kit (SDK) that allows third party developers to add novel multimedia overlays and tickers to the news media files. The overlays may be synchronized with the news media files or executed independently. In some embodiments, users may configure their own personalized content as an overlay. For example, the user may be watching a stock market collapse video with their own stock portfolio ticker running at a predetermined location on the screen of the user device. In another example, a user may overlay their own fantasy football team stats while they are watching a live football game.

Such overlays may be positioned anywhere on the canvas of a news media file and may be synchronized to specific segments in time to create a unique and dynamic viewing experience. The overlays may allow the social news platform 102 to embed rich information within the content of the news media file, making the news content more descriptive and engaging. In one embodiment, hotspots that appear either continuously or at predetermined time segments during a display of a news media file make any object within a canvas of the news media file content clickable for extended browsing and purchasing opportunities.

### Example Processes

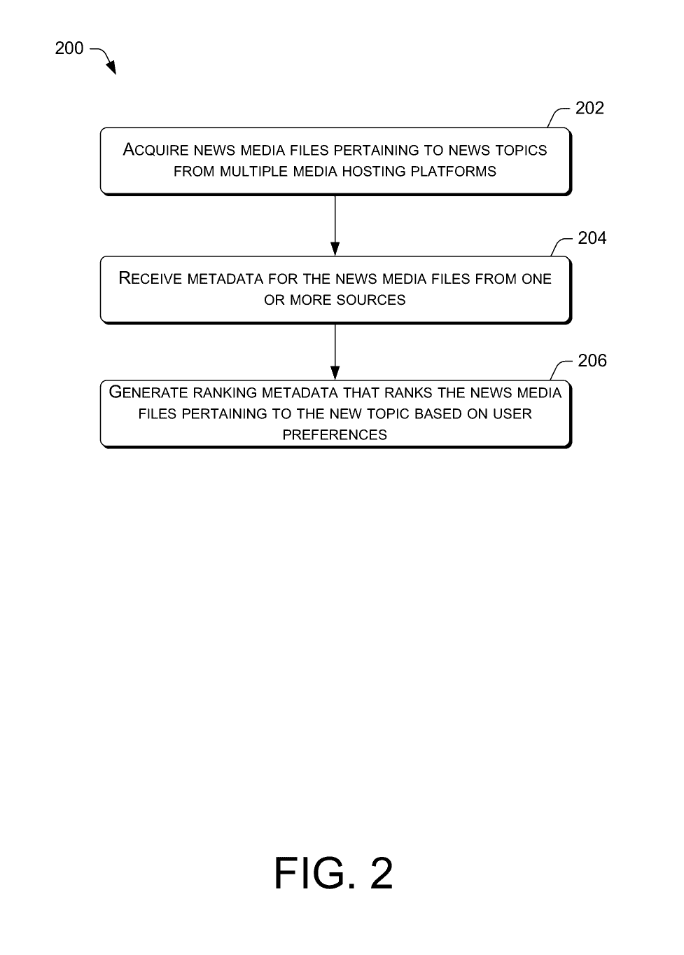

With the foregoing overview of the architecture 100 of the social news platform, it may be helpful now to consider a high-level discussion of example call flow processes. To that end, FIGS. 2 to 5 illustrate high level example call flow processes 200 to 500 for performing social news aggregation and distribution. Each of the processes 200 to 500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 200 to 500 are described with reference to the architecture 100 of FIG. 1.

FIG. 2 is a flow diagram of an example process for collecting news media files and generating metadata for such news media files via the social news platform 102. At block 202, the social news platform 102 may acquire news media files pertaining to news topics from multiple media hosting platforms, such as YouTube®, Facebook®, or other third party platforms as well as individual users. In various embodiments, the news media files may be acquired via the use of application plugins for content upload and viewing applications that are executing on user devices, browser add-ons for web browsers provided by the social news platform 102, and/or direct uploads to the social news platform 102.

At block 204, the social news platform 102 may receive metadata for the news media files from one or more user devices of users who are subscribed to the social news platform discussed herein. In various embodiments, the metadata may include hashtags, content descriptions, uploaded location information, statistics, user preferences, and other related data provided by content authors, content curators, content uploaders, content viewers, etc.

At block 206, the social news platform 102 may generate rankings for the news media files based on the viewing preferences of the viewers. In one embodiment, these rankings by the social news platform 102 may be based on the average of individual rankings of the news media files (i.e., by subscribed users). For example, viewers of the news media files may use a suitable rating scale to indicate their appreciation of a news media file. Such ratings are aggregated by social news platform 102 to identify the most popular content. In one embodiment, the social news platform 102 may rate a news media file by the number of views for different time periods (e.g., in the last hour, day, week, month, etc.).

The aggregation of ratings may be made via different kinds of incoming metadata from users. In one embodiment, a first user may provide a first metadata on a news media file and a second user may provide a second metadata on the news media file, wherein the first metadata and second metadata are of different type. For example, the first metadata will be a hashtag and the second metadata is a rating scale from 1 to 5. The social news platform 102 may generate a first intermediate score for the first metadata and a second intermediate score for the second metadata, where the intermediate scores use the same common scale. In our example, the common scale may be a score from 0 to 10 (including fractions). The social news platform 102 may take the hashtag as a binary value (either the hashtag is applied or it's not) and assign a score of 10 (as opposed to 0 if the hashtag was not applied). The second metadata may arrive as the value of 4 (with 5 being the most desirable value), and the social news platform 102 may then provide a scaled value of 8 (i.e., (10/5)×4). The social news platform 102 may then take the first score of 10 and the second score of 8, and then apply an aggregate value of 9 (i.e., the average of 10 and 8).

There are many ways to create an aggregate score. In one embodiment, each source of metadata may be assigned a profile by the social news platform 102, where the profile includes information on how to scale, weight, or otherwise modify use metadata from that source. For scaling, some metadata sources are from 1 to 5 (e.g., with 5 being the best), and others are from 5 to 1 (e.g., with 1 being the best). Yet other metadata sources may be from 1 to 10 (e.g., with 10 being the best). The profiles provide the conversion information to scale to the common scale.

In the case of weights, some sources of metadata may be weighted more than others, as indicated by profile. The weighting may be absolute. For example, the inclusion of a metadata source may be assigned a weight of 0.4 when used in the aggregation of any scores. Alternatively, weighting may be relative to other scores. For example, inclusion of a particular metadata source may be assigned a weight of 0.4 only when it is being aggregated with a specific other metadata source. In other embodiments, particular values from a source of metadata may have different weights. For example, a metadata source may provide multiple hashtags, with particular hashtags weighted higher than others.

Metadata sources need not come in the form of a preset scale. A metadata source may include commentary and/or annotations from users. In these cases, the social news platform 102 may parse the commentary and generate a score. For example, the social news platform 102 may parse for keywords, and the presence of certain keywords will trigger a score. In other circumstances, natural language processing (NLP) may be applied to find particular semantically equivalent phrases and/or expressions, each of which will trigger a score.

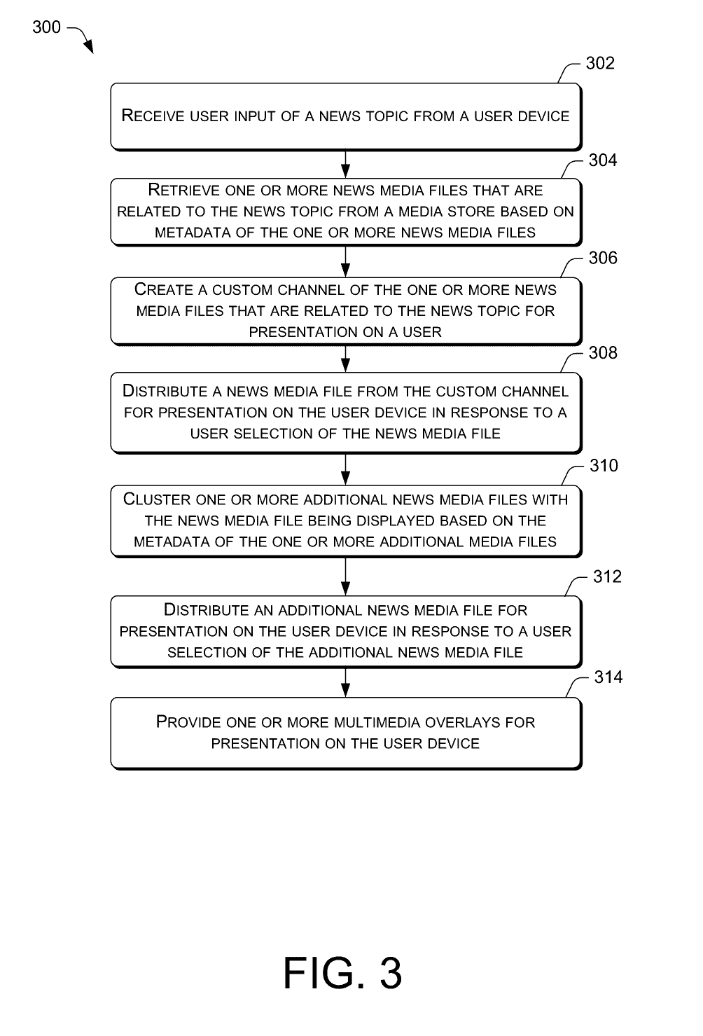

Reference now is made to FIG. 3, which is a flow diagram of an example process 300 for providing news media files that pertain to a news topic, to a user using the social news platform 102. At block 302, the social news platform 102 may receive a request for a news topic. The request, may be from a user application on a user device that the user is using to select and view news media files. In various embodiments, the application may be a plugin or a browser add-on application. For example, the user application may be executing on a smart TV or a regular TV that has been transformed into a smart TV via a dongle.

At block 304, the social news platform 102 may retrieve one or more news media files that are related to the news topic from the data store 140 based on metadata of the one or more news media files. In other words, the social news platform 102 may search the data store 140 for news media files that match the news topic using a search query and retrieve the one or more matching news media files.

At block 306, the social news platform 102 may create a custom channel of the one or more news media files that are related to the news topic for presentation to the user. In various embodiments, the channel may be presented to the user via the user application on the user device.

At block 308, the social news platform 102 may distribute a news media file from the custom channel for presentation on the user device in response to a user selection of the news media file. In various embodiments, the content selection may be by watching a continuous stream of system-wide content submissions ordered by ranking, viewing a custom channels based on metadata filters, selecting one or more related news media files, subscribing to custom playlists of news media files created by other users, etc.

At block 310, the social news platform 102 may cluster one or more additional news media files with the news media file being displayed, based on the metadata of the one or more additional news media files. In various embodiments, the metadata of each of additional news media file may indicate what news topic the news media file relates to.

At block 312, the social news platform 102 may distribute an additional news media file of the cluster of news media files for presentation on the user device in response to a user selection of the additional news media file. At block 314, the social news platform 102 may provide one or more multimedia overlays for presentation on the user device. In various embodiments, the multimedia overlays may include clocks, news tickers, stock quotes, sports scores, weather forecasts, poll results, statistical data and/or social network updates. The social network updates may be from Twitter, Facebook, and/or other third party platforms.

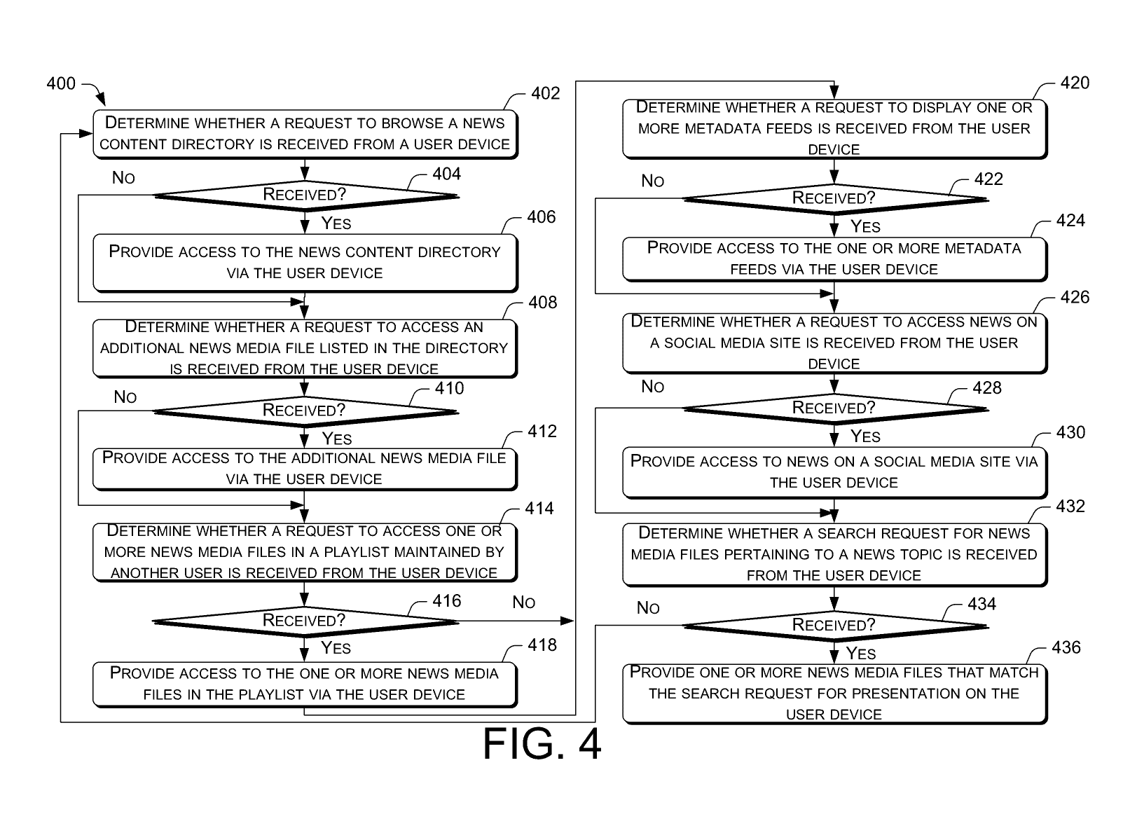

FIG. 4 is a flow diagram of an example process 400 for managing the user experience of a user who is interacting with the social news platform through a user device. At block 402, the social news platform 102 may determine whether a request to browse a news content directory is received from a user device. For example, the user device may be the user device 122 of the user 120. The requests may be made by the user application 124 executing on the user device 122. Accordingly, at decision block 404, if the social news platform 102 determines that the request to browse a news content directory is not received from the device (“no” at decision block 404), the process 400 may proceed directly to block 408. However, if the social news platform 102 determines that the request is received (“yes” at decision block 404), the process 400 may proceed to block 406, where the social news platform 102 may provide access to the news content directory via the user device.

At block 408, the social news platform 102 may determine whether a request to access an additional news media file listed in the directory is received from the user device. Accordingly, if the social news platform 102 determines that the request to access an additional news media file listed in the news content directory is not received from the user device (“no” at decision block 410), the process 400 may proceed directly to block 414. However, if the social news platform 102 determines that the request is received (“yes” at decision block 410), the process 400 may proceed to block 412, where the social news platform 102 may provide access to the additional news media file via the user device.

At block 414, the social news platform 102 may determine whether a request to access one or more news media files in a playlist maintained by another user, referred to herein as a curated playlist, is received from the user device. Accordingly, if the social news platform 102 determines that the request to access one or more news media files in a playlist is not received from the user device (“no” at decision block 416), the process 400 may proceed directly to block 420. However, if the social news platform 102 determines that the request is received (“yes” at decision block 416), the process 400 may proceed to block 418. At block 418, the social news platform 102 may provide access to the one or more news media files in the playlist via the user device.

At block 420, the social news platform 102 may determine whether a request to display a metadata feed is received from the user device. Accordingly, at decision block 422, if the social news platform 102 determines that the request to display one or more metadata feeds is not received from the user device (“no” at decision block 422), the process 400 may proceed directly to block 426. However, if the social news platform 102 determines that the request is received (“yes” at decision block 422), the process 400 may proceed to block 424. At block 424, the social news platform 102 may provide access to the one or more metadata feeds via the user device.

At block 426, the social news platform 102 may determine whether a request to access news from a social media site is received from the user device. Accordingly, at decision block 428, if the social news platform 102 determines that the request to access news on a social media site is not received from the user device (“no” at decision block 428), the process 400 may proceed directly to block 432. However, if the social news platform 102 determines that the request is received (“yes” at decision block 428), the process 400 may proceed to block 430. At block 430, the social news platform 102 may provide access to the news on a social media site via the user device.

At block 432, the social news platform 102 may determine whether a search request for news media files pertaining to a news topic is received from the user device. Accordingly, at decision block 434, if the social news platform 102 determines that the search request for news media files pertaining to a news topic is not received (“no” at decision block 434), the process 400 may loop back to block 402. However, if the social news platform 102 determines that the request is received (“yes” at decision block 434), the process 400 may proceed to block 436. At block 436, the social news platform 102 may provide one or more news media files that match the search request for presentation on the user device.

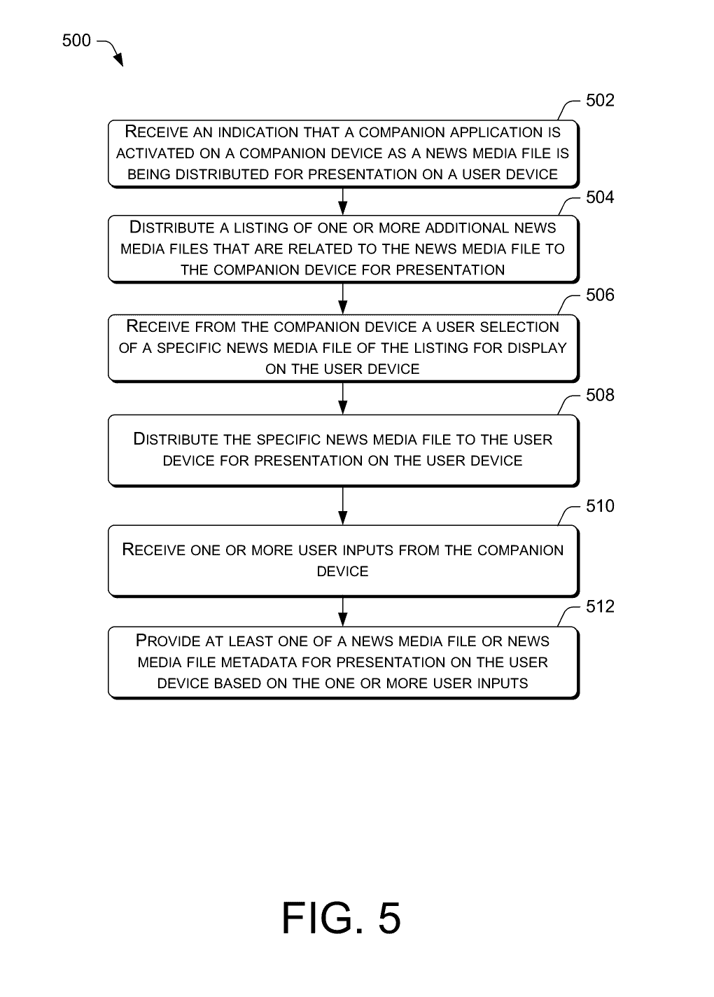

FIG. 5 is a flow diagram of an example process 500 for managing the user experience of a subscribed user who is interacting with the social news platform through a user device and a companion device. At block 502, the social news platform 102 may receive an indication that a companion application is activated on a companion device as a news media file is being distributed for presentation on a user device. In various embodiments, the companion device may be a second-screen device that is used by the same user. For example, the user device may be a smart TV of a user (or a regular TV that has been transformed into a smart TV via a dongle), and the companion device may be a tablet computer that is used by the same user.

At block 504, the social news platform 102 may distribute a listing of one or more additional news media files that are related to the news media file to the companion device. The listing of the one or more additional news media files may be displayed on the companion device. At block 506, the social news platform 102 may receive from the companion device a user selection of a specific news media file for display on the user device.

At block 508, the social news platform 102 may distribute the specific news media file to the user device for presentation on the user device. At block 510, the social news platform 102 may receive one or more user inputs from the companion device. In various embodiments, the user inputs may include media files rankings, metadata and annotations for media files, related media that is added to a current media file, media metadata and annotations, ticker and overlay configurations, media file search requests, and/or so forth.

At block 512, the social news platform 102 may provide at least one of a news media file or news media file metadata for presentation on the user device based on the one or more user inputs.

### User Experience

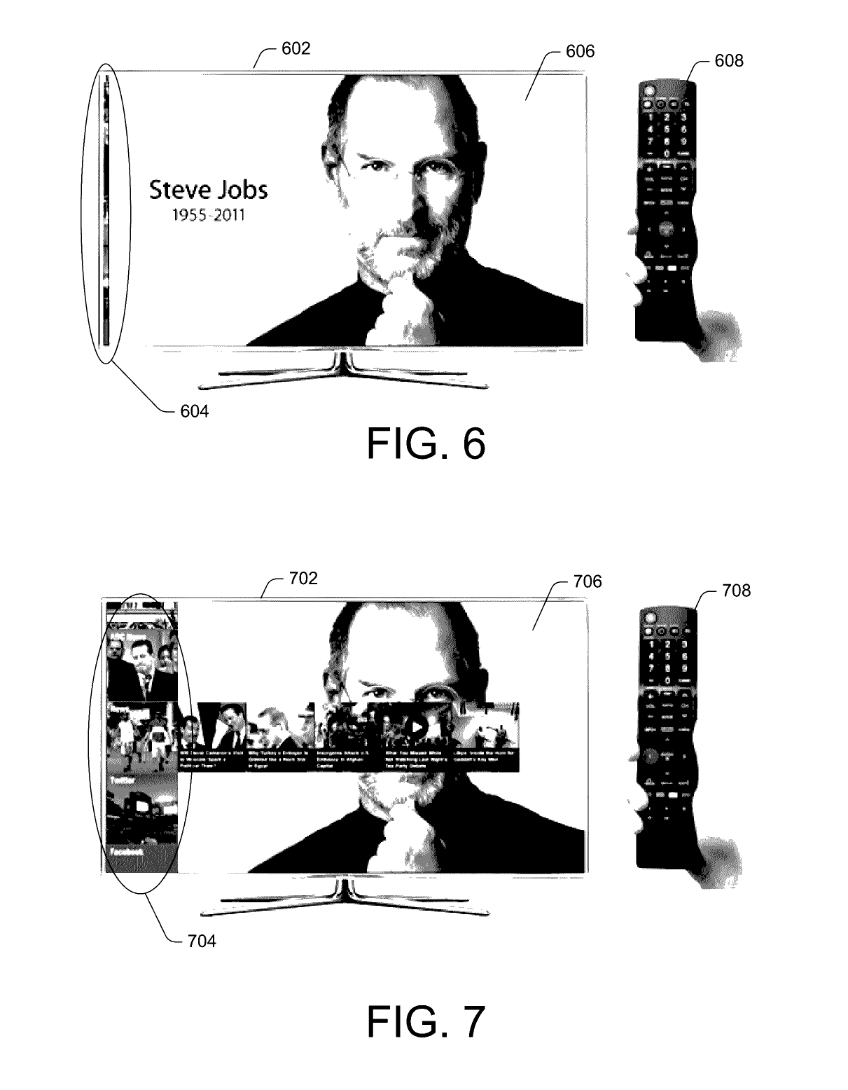

The concepts discussed herein provide highly interactive news that engages an audience in a meaningful way in that encourages participation. By way of illustrative example, FIGS. 6 to 14 provide views of a navigation workflow through the application, consistent with exemplary embodiments. FIGS. 6 to 14 depict implementations in accord with the present teachings by way of example only, not by way of limitation. Thus, many other workflow scenarios are supported as well in view of the teachings herein.

FIG. 6 illustrates an initial view of a media content, consistent with an exemplary embodiment. In various embodiments, the user device 602 may illustrate the content of the previously selected channel, an image of a major news story of the day, the most popular media file identified by the social news platform 102, etc. In one embodiment, the image 606 may be drawn from a subscribed user's social media sources. On one side of the canvas of the image 606, images of a list of content sources 604 may be displayed. In various scenarios, the media content sources 604 may be at any convenient location of the screen, such as the left side of the screen, as illustrated in FIG. 6. A user may navigate the user device via remote control 608 and/or directly via a touch screen of the user device 602.

In one embodiment, the user application that is running on the user device may configure the user device 602 to play the first video from the user's default playlist (i.e., instead of showing an image at startup) to provide a user with an experience of tuning to a broadcast TV channel. For new users, the default playlist may include a global playlist of all videos ordered by a ranking and/or in chronological order.

FIG. 7 illustrates a selection of media content sources, consistent with an exemplary embodiment. A user may open the list of media content sources 704 via remote control 708 having a directional pad (D-pad) or touchpad to select a desired news story, as illustrated in FIG. 7. In one embodiment, the touch screen of the user device 702 may be used to make this selection. The media content may be provided by a content provider, such as a traditional news station, social networking site, etc., collectively represented by the media store 142 in FIG. 1.

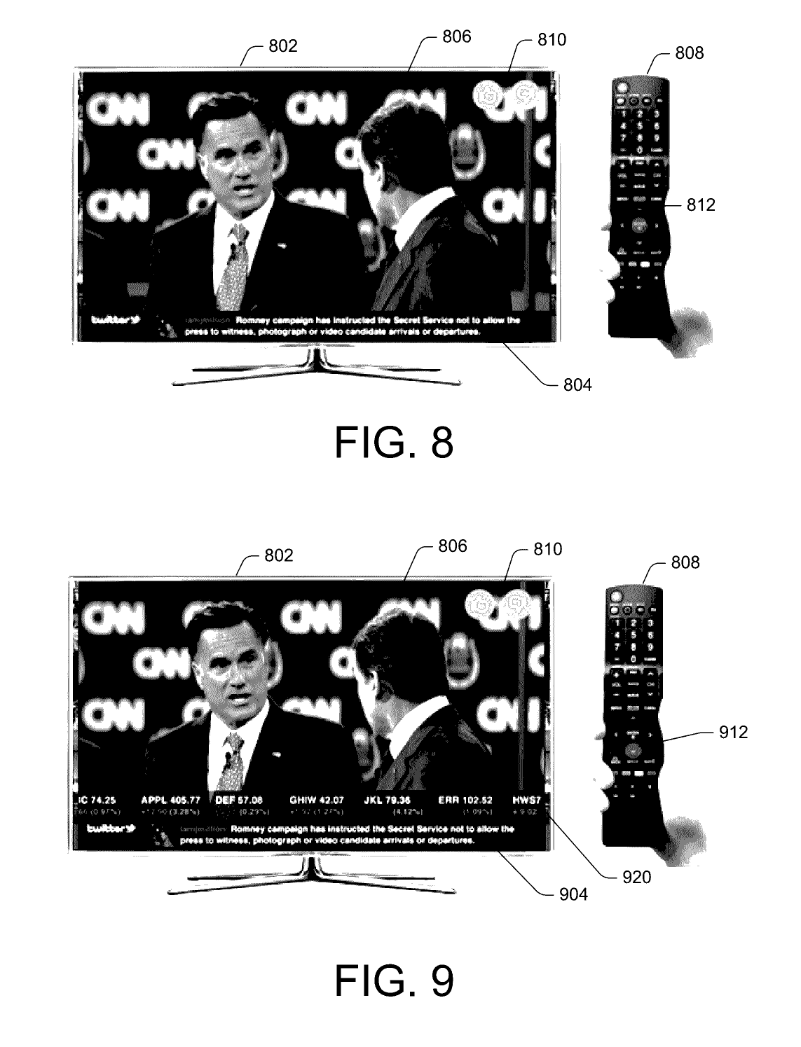

FIG. 8 illustrates a news media file 806 playing on a user device 802 with a multimedia overlay 804, consistent with an exemplary embodiment. By way of example, FIG. 8 illustrates that twitter comments in connection with a particular time segment of a news media file 806 being displayed at the lower portion of the screen. A user may press “select” either on the remote control to begin watching a particular news media file or a selected playlist. In one embodiment, where a touch sensitive screen is used for the user device 802, a user may simply tap the touch sensitive screen in order to play the news media content. Upon selection, the user application on the user device 802 may automatically open a multimedia overlay 804 (e.g., Twitter in the present example) with tweets related to different time segments of the story.

A user may rank a news media file (e.g., based on their personal viewing preferences) by making a binary assertion of whether they appreciate the news media file (e.g., thumbs up or down 810). Alternatively, another suitable rating scale may be used, as discussed previously. To that end, the user may press the UP button on the D-pad 812 to activate the Like/Dislike buttons and to make a selection.

In one embodiment, related media content items may be offered at any convenient location of the screen, such as the left or right side of the screen, which may be invoked via remote control 808 and/or directly via a touch screen of the user device 802 (when equipped with such user interface). The rating is sent to the social news platform 102, which records the user's vote in the data store 140. Such ratings from various users allows the social news platform 102 to recalculate rankings for any media file, playlist, filer, or search results the news media file belongs to for all users of the social news platform 102. In one embodiment, these ratings enable a processor of the social news platform 102 to provide an ordered list or channel of the most salient videos in a category. For example, the highest ranked #ElectionDebate videos of the day may be provided. In some embodiments, the time frame for the filter may be selected by the user (e.g., by day, month, all time, etc.)

FIG. 9 illustrates a news media file 802 playing on a user device 802 with multiple multimedia overlays 904 and 920, consistent with an exemplary embodiment. A user may add various custom overlays, such as tickers, to the viewing area. For example, these overlays may include, but are not limited to, news tickers, stock quotes, sport scores, weather forecasts, poll results, statistical data, and social network updates (e.g., from Twitter, Facebook, and other third party social networking platforms).

The ability to customize the ticker data to personal needs represents a fundamental shift from traditional TV where ticker content is controlled by the broadcaster. For example, a stock ticker provided by the social news platform may display a user's personal portfolio and the sports ticker shows his or her favorite team results. Note that the same level of personalization may be available for any data presented outside the ticker area, such as floating weather bugs and polls. In various embodiments, the overlays may be placed at different locations on the display of the user device 802.

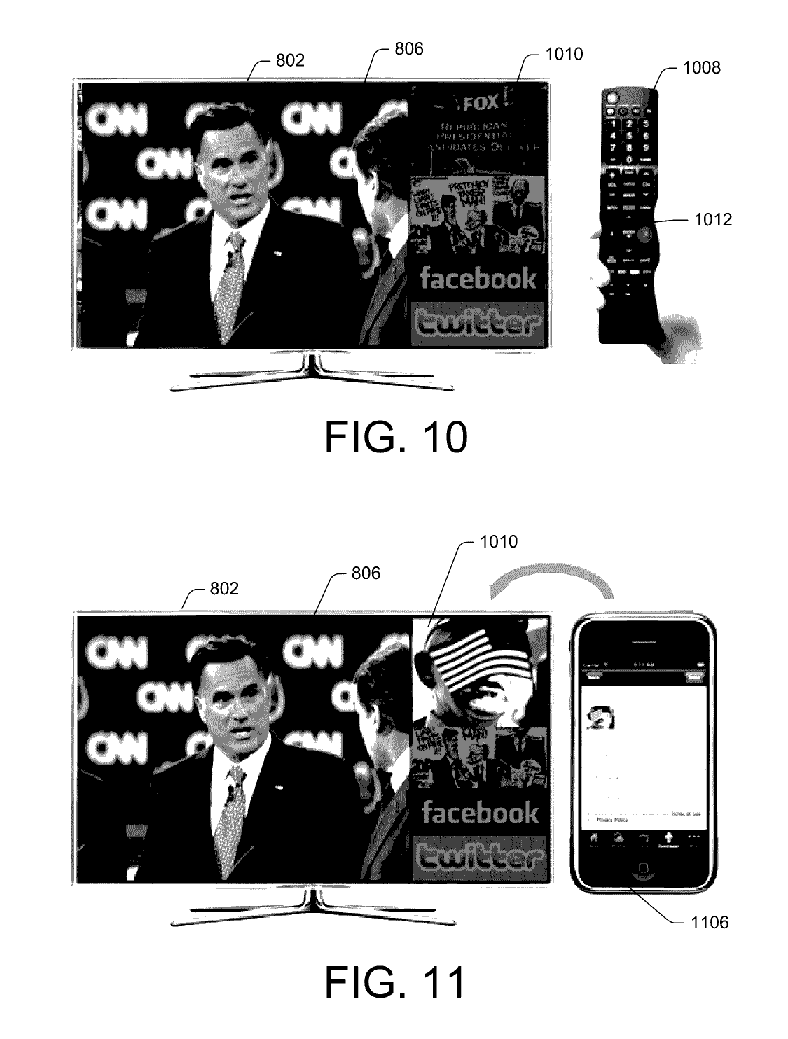

FIG. 10 illustrates a news media file 806 playing on a user device 802 while related content 1010 is being reviewed by a user, consistent with an exemplary embodiment. For example, a user may press a button (e.g., right button on the D-pad) 1012 on the remote 1008 to invoke a related content list 1010. In one embodiment, the related content is correlated using machine learning and clustering, as well as professional and crowd curation. For example, machine learning may be used herein to construct algorithms that can learn from and make media content favorability predictions based on the data stored in the data store 140. Such algorithms operate by building a model from stored prior inputs or baselines therefrom in order to make data-driven predictions or decisions, rather than following strictly static criteria. Based on the machine learning, patterns and trends in viewing habits/preferences for different audiences are identified and an appropriate content is made available by the social news platform 102. In various embodiments, the machine learning may make use of techniques such as supervised learning, unsupervised learning, semi-supervised learning, naïve Bayes, Bayesian networks, decision trees, neural networks, fuzzy logic models, and/or probabilistic classification models.

FIG. 11 illustrates a news media file being uploaded to the social news platform 102 as a related file, consistent with an exemplary embodiment. For example, an application on a handheld user device 1106 may be used to directly upload one or more media files to the social news platform 102. An uploaded news media file may be pushed to the social news platform 102 as part of a related content list 1010. Alternatively, a news media file may be provided as a new news item. Such uploading of news media files may be in real time (i.e., allowing for expected transfer/processing delays), such that other subscribed users may enjoy the newly added related content.

In one embodiment, the application on the handheld user device 1106 may publish a continuous live stream of video instead of uploading a complete file. This capability of providing user generated content (UGC) via a live stream may be particularly useful when witnessing a live event (e.g., a car chase) which allows a user to provide live media content from their perspective as a news story develops. A viewer of the news media file may then select from several available UGC live feeds. In this regard, FIG. 11 illustrates a viewer selecting a new UGC item, consistent with an exemplary embodiment.

In general, UGC, as the name implies, is any content generated by a user of a service, as opposed to a source of information from within the service and/or site. Services and/or sites aggregate UGC from multitudes of users and then use the aggregated information for internal purposes and/or may publish back UGC to the user. UGC may include text in the form of commentary and/or annotations (commentary associated with items in a figure), multimedia content such as stills, audio and video. In the above scenario, the continuous live stream of UGC is video, but could alternatively be audio, or a running commentary.

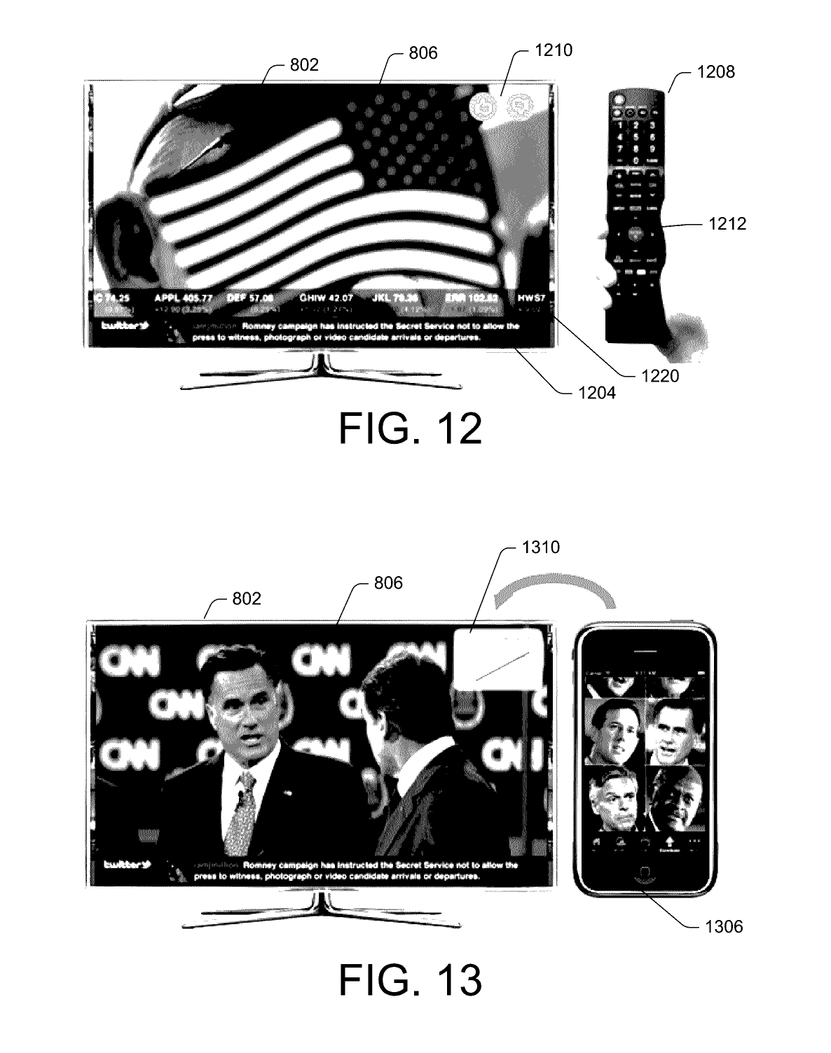

FIG. 12 illustrates a news media file being uploaded to the social news platform 102 as a related file, consistent with an exemplary embodiment. For example, a user may navigate and select a new UGC on their remote control 1208 by using the D-pad. In one embodiment, where a touch sensitive screen is used for the user device 802, a user may simply tap the touch sensitive screen in order to immediately stream the UGC. In one embodiment, various overlays, such as tickers and social media information related to the event may be provided on the user device 802. Additional related media content may continuously be made available (e.g., on the left or right side of the screen) as it becomes available through the social news platform 102. Subscribed users can then rate the live content (represented by way of example by a thumbs up/down 1210). The rating of the live news media content may be used by the social news platform 102 to rank it accordingly, as it is provided to other subscribed users. For example, live media content that receives a high rating may be pushed up while live media content that receives a lower rating is pushed down in the selection offered on the display of the user device 802.

A user may decide to return back to the original media content (e.g., which was viewed before the particular UGC was selected). To that end, in one embodiment, the social news platform 102 records the point at which a transition is made from one news media file to another. Accordingly, when a user returns to the original media content (e.g., by using a “back” button or function) on the remote 1208 or directly on a touch screen of the user device 802, the original news media file resumes playing from where it left off.

In one embodiment, the highly interactive architecture of the social news platform 102 makes possible for subscribed users to simultaneously participate in a poll. In this regard, FIG. 13 illustrates a second user device 1306 being used to provide a selection or a rating. The social news platform 102 may aggregate the polling and provide it on the display of a user device 802 watching the present live media file. Alternatively, a user may vote directly on the first user device 802 (e.g., TV in the present example) by using its touch screen or by using a remote control associated with the user device 802.

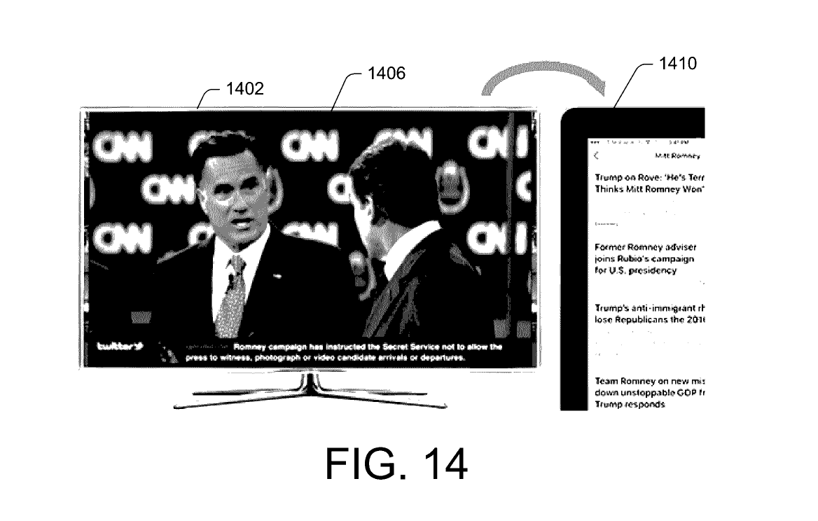

In one embodiment, a subscribed user can install a social news platform companion application on various user devices, such as a smart TV, mobile device, tablet computer, smart watch, etc., collectively referred to herein as a second-screen device. In this regard, FIG. 14 illustrates a second-screen device 1410 interacting with a first screen device 1402, consistent with an exemplary embodiment. The second-screen device 1410 may automatically display media content related to the news media file presently being watched on their first user device (e.g., user device in the form of a smart TV). Conversely, a user may browse content on the second-screen device 1410 and queue it for viewing on the first user device 1402. For example, a Discovery and Launch (DIAL) protocol may be used for discovering and launching applications on a single subnet (e.g., a home network where both the first screen device and the second-screen device are operating). The second-screen device 1410 may initiate the selected news media files to be played on the first screen device 1402. The second-screen device 1410 may be used to perform the various features of a user device discussed above, including (without limitation): (i) ranking a news media file that is presently being watched on the first screen device; (ii) adding metadata to the news media file; (iii) adding related media to the news media file; (iv) configuring overlays to be displayed in tandem with the news media file; (v) configuring content sources and filters for the user profile; and (vi) searching various content providers (e.g., represented by media store 142 in FIG. 1) for news media files.

### Example Computer Platform

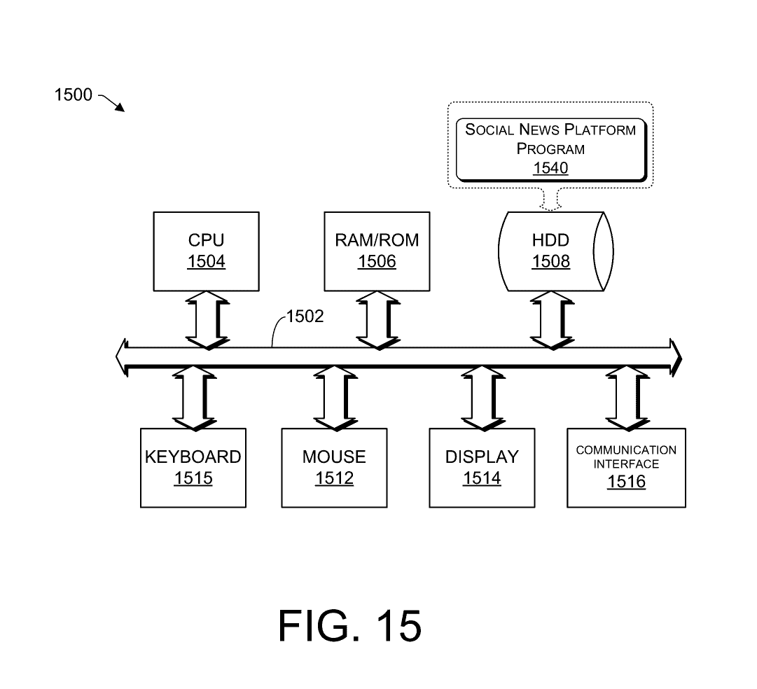

As discussed above, functions relating to the social news platform system discussed herein can be performed with the use of one or more computing devices connected for data communication via wireless or wired communication, as shown in FIG. 1 and in accordance with the processes of FIGS. 2 to 5. FIG. 15 provides a functional block diagram illustration of a computer hardware platform 1500 that may be used to implement the functionality of the one or more computing devices of the social news platform 102.

The computer platform 1500 may include a central processing unit (CPU) 1504, random access memory (RAM) and/or read only memory (ROM) 1506, a hard disk drive (HDD) 1508, a keyboard 1510, a mouse 1512, and display 1514, which are connected to a system bus 1502.

The memory 1506 and 1508 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. The memory may store modules that perform the functions associated with the social news platform 102 as described in this disclosure. The modules may include routines, program instructions, objects, and/or data structures that perform particular tasks or implement particular abstract data types.

In one embodiment, the HDD 1508, has capabilities that include storing a program that can execute various processes, such as those of the social news platform program 1540, in a manner described herein. The social news platform program 1540 may have various modules configured to perform different functions to facilitate the receiving, organizing, and providing news media files to user devices and second screen devices of subscribed users.

In one example a program, such as Apache™, can be stored for operating the system as a Web server. In one embodiment, the HDD 1508 can store an executing application that includes one or more library software modules, such as those for the Java™ Runtime Environment program for realizing a JVM (Java™ virtual machine).

### CONCLUSION

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

It is understood that any specific order or hierarchy of steps in the flow processes disclosed herein are illustrations of exemplary approaches. Based upon design preferences, it is understood that the specific order or hierarchy of steps in the processes may be rearranged, expanded, and some steps omitted. Some of the blocks may be performed simultaneously.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A computing device comprising:
a processor;
a network interface coupled to the processor configured to enable communications via one or more communication networks;
a memory for content and programming;
a social news platform application stored in the memory, wherein execution of the application by the processor configures the computing device to perform acts comprising:
receiving news media files from subscribers of a social news platform via the one or more communication networks;
receiving metadata for one or more corresponding news media files from the subscribers via the one or more communication networks;
rating each received news media file based at least on the received metadata;
storing each news media file and its corresponding metadata in a memory of the computing device;
retrieving one or more news media files that are related to a news topic from the memory of the computing device;
creating a custom channel comprising a dynamic playlist of the one or more news media files that are related to the news topic;
determining an order in which to present the one or more news media files of the custom channel based on the rating of each media file in the custom channel; and
providing the custom channel comprising the one or more news media files in the determined order, to be presented to user devices of the subscribers.

2. The computing device of claim 1, wherein each of the news media files is received via at least one of:
i) an application plugin configured for content upload that is running on a user device; and
ii) a browser add-on running on a browser of the user device.

3. The computing device of claim 2, wherein a news media file is received by the social news platform application by following a link that is provided by the user device.

4. The computing device of claim 2, wherein a news media file is received as a push upload by the user device.

5. The computing device of claim 1, wherein:
the metadata of a news media file may include at least one of: a hashtag, a content description, a location information, and a statistic, and
the metadata is provided by at least one of: a content author of the news media file, a content curator, an uploader of the news media file, and a content viewer subscribed to the social news platform.

6. The computing device of claim 1, wherein the retrieving of the one or more news media files that are related to the news topic is in response to receiving a request for the news topic from a user device of a subscriber to the social news platform.

7. The computing device of claim 1, wherein execution of the application further configures the computing device to perform the act of determining which media files are related to a news topic based on the metadata of each news media file.

8. The computing device of claim 1, wherein execution of the application further configures the computing device to perform the acts of:
receiving a request for a new news topic from a user device of a subscriber to the social news platform; and
providing a second custom channel comprising a dynamic playlist of one or more news media files that are related to the new news topic to the user device.

9. The computing device of claim 1, wherein the custom channel is provided on a first-screen device upon request from a second screen device having stored thereon a companion application configured to control the first screen device.

10. The computing device of claim 1, wherein the received metadata is for a particular time segment of a news media file.

11. The computing device of claim 1, wherein execution of the application further configures the computing device to perform the act of receiving a news media package from a user device of a subscriber to the social news platform, wherein the news media package comprises several news media files that are indicated to belong together by the user device.

12. The computing device of claim 1, wherein execution of the application further configures the computing device to perform the act of providing an overlay of a data feed for presentation on a user device in response to a request for the overlay from the user device.

13. The computing device of claim 12, wherein the overlay provides content from a social networking site.

14. The computing device of claim 12, wherein the overlay is based on personalized context of a subscriber watching the data feed.

15. The computing device of claim 1, wherein execution of the application further configures the computing device to perform the act of routing a user generated content (UGC) as a live stream, provided by a first user device, to a second user device, wherein the live news media data feed is routed from the first user device to the second user device in response to a request for the UGC from the second user device.

16. The computing device of claim 1, wherein execution of the application further configures the computing device to perform the act of providing hotspots that appear at predetermined time segments during a display of a news media file to make an object within a canvas of the news media file content clickable for a purchasing opportunity.

17. A non-transitory computer-readable medium having stored thereon a plurality of sequences of instructions which, when executed by a processor, cause the processor to perform a method of providing a social news platform, the method comprising:
receiving news media files from subscribers of the social news platform via the one or more communication networks;
receiving metadata for one or more corresponding news media files from the subscribers via the one or more communication networks;
rating each received news media file based at least on the received metadata;
storing each news media file and its corresponding metadata in a memory of a computing device of the social news platform;
retrieving one or more news media files that are related to a news topic from the memory of the computing device;
creating a custom channel comprising a dynamic playlist of the one or more news media files that are related to the news topic;
determining an order in which to present the one or more news media files of the custom channel based on the rating of each media file in the custom channel; and
providing the custom channel comprising the one or more news media files in the determined order, to be presented to user devices of the subscribers.

18. The non-transitory computer-readable medium of claim 17, wherein each of the news media files is received via at least one of:
i) an application plugin configured for content upload that is running on a user device; and
ii) a browser add-on running on a browser of the user device.

19. The non-transitory computer-readable medium of claim 18, wherein a news media file is received by the social news platform application by at least one of: (i) following a link that is provided by the user device, and (ii) as a direct push upload by the user device

20. The non-transitory computer-readable medium of claim 17 wherein the custom channel is provided on a first-screen device upon request from a second screen device having stored thereon a companion application configured to control the first screen device.

21. The non-transitory computer-readable medium of claim 17, wherein execution of the application further configures the computing device to perform the act of providing an overlay of a data feed for presentation on a user device in response to a request for the overlay from the user device.

22. The non-transitory computer-readable medium of claim 17, wherein execution of the application further configures the computing device to perform the act of routing a user generated content (UGC) as a live stream, provided by a first user device, to a second user device, wherein the live news media data feed is routed from the first user device to the second user device in response to a request for the UGC from the second user device.
